(19) United States
(12) Patent Application Publication
(10) Pub. No.: US 2001/0049297 A1
(43) Pub. Date: Dec. 6, 2001

(54) System for online creation, playing and administering of user defined puzzles

(76) Inventors: John M. Hibscher, North St. Paul, MN (US); Linda B. Cline, Glencoe, IL (US)

Correspondence Address: ALTHEIMER & GRAY, TEN SOUTH WACKER DRIVE, SUITE 4000, CHICAGO, IL, 60606-7482, US

(21) Appl. No.: 09/741,564

(22) Filed: Dec. 18, 2000

Related U.S. Application Data
(60) Provisional application No. 60/171,165, filed on Dec. 16, 1999.

(51) Int. Cl. A63F 9/24; G06F 17/00; G06F 15/16

(52) U.S. Cl. 463/9; 707/104.1; 709/217; 709/219

(57) ABSTRACT

An online puzzle system for allowing a user to create, edit, store and access computer games, such as puzzles, via a remote computer in conjunction with the Internet. The user accesses the online puzzle system via the remote computer which includes a Web browser. The puzzle system also provides a plurality of functions, such as creating, editing, storing and accessing puzzles, to the user by presenting a plurality of commands, in the form of Web site hyperlinks, to the Web browser. Once the user selects one of the commands or hyperlinks, a correlating Web page may be accessed. The Web page may then request the game data needed to accomplish the corresponding function. Finally, the puzzle system may apply the design rules to the game data and dynamically generate a computer game which can be played by the user via the remote computer in conjunction with the Web browser.

This application claims the benefit of provisional application Ser. No. 60/171,165 filed on Dec. 16, 1999.

### BACKGROUND OF THE INVENTION

1. Field of the Invention

The present invention relates generally to puzzles and more specifically to a system that allows users to create, play and access puzzles online.

2. Description of the Prior Art

Puzzle games which test a user's mental acuity have long provided an educational activity and entertainment to millions of people. For many years, newspapers and other periodicals have published crossword puzzles and other word puzzles as a form of entertainment for their readers. Puzzle games have been constructed for users of varying ages and levels of knowledge. Educators around the world use word and math puzzles as an educational tool to increase students' vocabulary and mathematical skills.

Methods for creating puzzle games are well-known in the prior art. Some puzzles can even be designed and manually constructed rather easily. Crossword or word search puzzles, however, often require expert puzzle-construction skills. Previous inventions exist that facilitate the creation of such puzzles with the assistance of computer software products. These software products have made constructing, editing and playing user-defined puzzles easier and these software products are readily accessible. The proliferation of these software products has allowed puzzle creators to utilize more features during the creation of user-defined puzzles. For example, these software products have allowed additional features to be included such as, graphical user interfaces, customizable fonts and colors, background images and print functionality. Despite the additional features now available to puzzle creators, most software products only provide means for creating one puzzle type. Consequently, users must purchase separate and multiple software products to create a variety of puzzles. A comprehensive system for creating a variety of puzzle games does not exist.

The continuous advancement of the computer hardware and software industry has led to numerous technological innovations that enhance business, entertainment and education. Moreover, with the advent of the Internet, resources for entertainment and education have multiplied at an exponential rate. This has resulted in the availability of a variety of puzzle games on the Internet, and more specifically, on the World Wide Web. These online puzzles are available to any user with a Web browser and Internet access.

Puzzles on the World Wide Web exist in many forms. The simplest form provides puzzles as standard Web content, using any combination of HyperText Transfer Protocol (HTTP), HTML Forms, HTML Frames and Illustrations or Graphics. User may view these puzzles with Web browsers which are connected to the Internet and play these puzzles by clicking on hyperlinks or submitting answers through basic HTML Forms. Users can also print a hard copy of the puzzle for their entertainment. These puzzles, however, are limited in their interactivity and complexity due to the nature of standard Web content and limitations of HTML. For example, playing HTML puzzles involves the continuous interaction between the Web browser and the Web server. This results in an efficient and non-dynamic system for playing a puzzle on line. Another disadvantage with HTML-based systems involves creating puzzles. HTML does not provide the capability of instantaneously generating a puzzle based on user-defined data. Specifically, Web servers do not have the functionality to interpret data and dynamically generating an output based on information on information received from the Web browser. In order to provide HTML-based puzzles over the Internet, the puzzle must be created using existing puzzle creation technology and then translated into HTML. Subsequent advancements in Internet, software tools and technology have provided Internet users with more complex and dynamic capabilities for viewing, editing and exchanging Web content.

Software developments such as Java and ShockWave are a few of the technological advancements which have enriched the content of the World Wide Web. These improvements have improved the ability to deliver multimedia over the Internet. The ability to deliver multimedia via the Internet had previously been restricted by band width limitations. With the implementation of data compression schemes, multimedia files can now be viewed over the Internet with few or no complications. Java, which was developed by Sun Microsystems, refers to the programming language used to develop Java applets. Applets are compact application programs that are downloaded from a Web server, and then executed by a Web browser to minimize the latency caused by limited band width. All Web browsers have the capability to download and execute Java applets. ShockWave, developed by Macromedia, works similarly to Java. Instead of applets, however, ShockWave technology uses compact programs called movies. These movies are downloaded to the Web browser, where a ShockWave plug-in executes the movie for a user to view. Aside from adding a multimedia dimension to standard Web pages, Java and ShockWave also extend the Web sites interactivity. These small but robust applications provide for a complex level of logical and interactivity within the browser. On the other hand, HTML-based systems are capable of performing hyperlink requests, image display and page formatting. These improvements and the other plug-ins which have been developed have dramatically increased the capabilities of the Internet and have brought Web-based puzzles to a higher level. Plug-in applications are computer programs which run concurrently with Web browser software to extend its capabilities beyond merely displaying standard HTML pages. For example, the ShockWave browser plug-in developed by Macromedia Corporation allows Web browsers to display interactive multimedia content such as sound and animation. Other plug-ins have been developed by Microsoft, Abode, Real Media and others. Currently, Java applets are being used to deliver playable puzzles on the World Wide Web. Additionally, numerous newspapers, periodicals and other companies have published daily or weekly crossword puzzles on their Web sites. Because Java allows users to dynamically exchange information with a Web site, users can play or solve crossword puzzles entirely on line using mouse clicks and keyboard inputs. Another feature of the Java-based puzzles is the dynamic feedback provided by an applet without communicating with the Web server. For example, a user can be instantaneously notified of a incorrect answer without exchanging any information with the Web server. Constructing puzzles and games by using Java applets requires software development tools and advanced programming skills. Once the applet is developed, it must be installed onto a Web server that is connected to the Internet. These skills and processes are uncommon to the average Internet user and present a challenging obstacle to anyone who wishes to create a Java-based puzzle.

ShockWave software has also been used to develop various puzzles and games for use on the Internet. ShockWave puzzles operate similarly to Java-based puzzles, but can only be viewed by a Web browser using the ShockWave plug-in. The creation of ShockWave puzzles requires two main steps. The first step involves using Macromedia Director, a popular authoring software product, to create a Director movie that displays the puzzle. Then, the Director movie is translated into the Internet-ready ShockWave format. Although the necessary programming skills are not as demanding as those associated with Java applets, the skills needed to create Director movies may still be too advanced for the average user. Creators are also faced with the same obstacles discussed above in regard to creating Java-based puzzles. The advent of Java and ShockWave technology has undoubtedly brought a new dimension to Web-based puzzles with features such as, multimedia capability, complex interactivity and Internet delivery. For example, these additional features have yielded numerous puzzles that can be played via the Internet from anywhere in the world. However, currently there is not a user-friendly system which allows an average user to create the type of online puzzles discussed above.

There are also several online puzzle-creating systems and methods which combine one or more of the previously discussed technologies. For example, Internet Crossword Creator by Centron Software, uses a similar system to that of Macromedia. After users install the software onto a computer, the software employs a computerized algorithm to generate a crossword puzzle based on user-defined data. A user can then utilize the software to convert the generated puzzle into a Java applet. There are other variations of this method which involve a plug-in or player module. As for the other puzzle software products, the Internet Crossword Creator only creates one type of puzzle. Although this software simplifies the creation process of online puzzles, additional steps must be performed in order to publish the puzzle on the World Wide Web for Internet distribution. The requirements for publishing Web pages on the Internet vary. At a minimum, a publisher must employ a Web server or have publishing access to a Web server. While there are companies that offer services that range from designing Web sites to maintaining and hosting Web sites, distributing a puzzle over the Internet can still be problematic. Note that these publishing obstacles apply to any type of Web content for which a user intends to distribute via the Internet, including Java, ShockWave and standard HTML pages.

From the foregoing, it is seen that a need remains for an improved system and method for generating, editing and allowing users to access puzzles. In particular, a need exists for a system and method for allowing users to create, edit, store and access computer games, such as puzzles, via a remote computer.

### SUMMARY OF THE INVENTION

To overcome the disadvantages noted above, the present invention is directed to a system and method for allowing a user to create, edit, store and access computer games, such as puzzles, via a remote computer in conjunction with the Internet. More specifically, the user may access the online puzzle system with the remote computer which includes a Web browser. The puzzle system may allow user to employ a plurality of functions, such as creating, editing, storing and accessing puzzles, by presenting a plurality of commands, in the form of Web site hyperlinks, to the Web browser. Once the user selects one of the commands or hyperlinks, a correlating Web page may be accessed and the Web page may then request the game data needed to accomplish the corresponding function. The puzzle system may then apply the design rules to the game data and dynamically generate a computer game which can be played by the user via the Web browser in conjunction with the remote computer. The puzzle system may utilize a Web server and an application server module to enable the puzzle system to exchange game data between the remote computer and the puzzle system.

A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF THE DRAWINGS

For a better understanding of the invention, reference may be had to a preferred embodiment shown in the following drawings in which:

FIG. 1 shows a block diagram of an exemplary system for allowing users to create, edit, store and access computer games, such as puzzles, via a remote computer;

FIG. 2 shows a block diagram of the remote computer shown in FIG. 1 and its interaction with the server computer;

FIG. 3 shows a more detailed block diagram of the application server module as shown in FIG. 1 and its interaction with the application server database;

FIG. 4 shows a flowchart depicting an exemplary method for allowing users to create, edit, store and access computer games, such as puzzles, via a remote computer;

FIG. 5A shows a flowchart depicting an exemplary method for allowing a user to execute the PLAY PUZZLE function.

FIG. 5B shows a flowchart depicting additional steps in the exemplary method for allowing a user to execute the PLAY PUZZLE function;

FIG. 6A shows a flowchart depicting an exemplary method for allowing a user to execute the CREATE PUZZLE function;

FIG. 6B shows a flowchart depicting additional steps in the exemplary method for allowing a user to execute the CREATE PUZZLE function; and

FIG. 7 shows a flowchart depicting an exemplary method for allowing a user to execute the EDIT PREVIOUS PUZZLE function.

### DETAILED DESCRIPTION OF THE INVENTION

While this invention is susceptible of embodiments in many different forms, there is herein described in detail, a preferred embodiment of the invention with the understanding that the present disclosure is to be considered as an exemplification of the principals of the invention and is not intended to limit the broad aspects of the invention to the embodiments illustrated herein.

Turning now to the figures, wherein like reference numerals refer to like elements, there is illustrated an on-line puzzle system 10 for allowing a user to create, edit, store and access computer games, such as puzzles, via a remote computer.

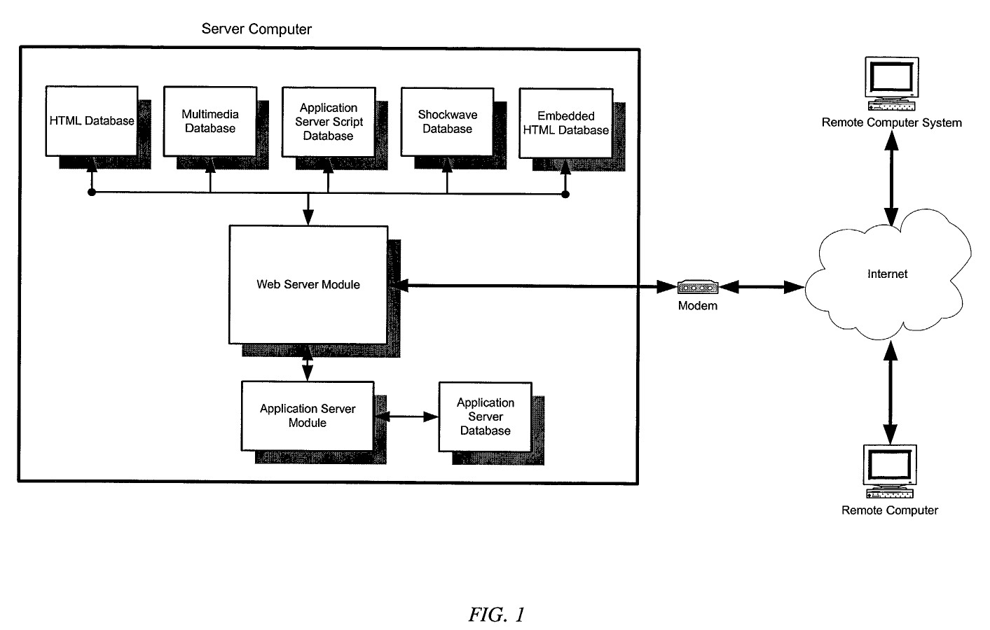

FIG. 1 shows a block diagram of the online puzzle system 10 in accordance with the present invention. Specifically, this illustration shows the software modules that interact with each other in order to provide the functions necessary to allow a user to create, edit, store and access puzzles via the system. As is well known in the art, the on-line puzzle system 10 is comprised of a server computer 20 and a plurality of remote computers 22 which are interconnected by and capable of exchanging game data 24 via the Internet 26 or a similar network of computers. The server computer 22 is comprised of a plurality of databases 28, an application server module 30, and an application server database 32. To connect the server computer 20 to the Internet, the server computer 20 may also include a modem 34 or similar device. The modem 34 may also be connected to the server computer 20 according to existing standards, such as via a serial port and a system bus, and may allow data to be accessible to users via the Internet 26. More particularly, the server computer 20 includes an HTML database 28a, a multimedia database 28b, an application server script database 28c, a shockwave database 28d and an embedded HTML database 28e.

From the user perspective, the puzzle system 10 exists as a Web site 36 on the Internet 26. The Web site 36 is accessible by most standard Web browsing software. Web browsers are software applications which allow users to interface with the Internet 26. The Web browser provides audio and visual information, or content, to the user and is also capable of linking users to other Web sites 36 by accessing hyperlinks, or similar tools. Thus, the Web browser allows the user to hear and see multimedia content on the Web sites 36 and to navigate within the Internet 26 from one Web site to another.

As is well known in the art, the remote computer 22 shown in FIG. 1 may also include a Web browser 38 which enables the remote computer 22 to display the Web site 36 embodying the puzzle system 10. Web browser software, such as Netscape Navigator or Microsoft Internet Explorer, may be stored on the remote computer 22 and the remote computer 22 may be connected to the Internet 26. The system 10 may further require a Web browser 38 that includes a plug-in module that allows the browser to display multimedia files, such as Macromedia Shockwave. A plug-in module is a software application that runs concurrently with Web browser software and that extends the capabilities of the Web browser 38 beyond being able to display standard HTML pages. Many recent versions of Web browser software are released with the Macromedia Shockwave plug-in module already installed. The Web browser 38 may be connected to the server computer 20 via the Internet 26. The Internet 26 is a global computer network that users can access through a variety of means. Some means for accessing the Internet 26 include using a modem 34 in conjunction with a standard phone line or using a Local Area Network (LAN) that directly interfaces with the Internet 26.

As shown in FIG. 1, the server computer 20 may be comprised several databases 28 which store corresponding files which are used to provide the Web site content for the puzzle system 10 available to users via the Web browser 38 of the remote computer 22. More specifically, as discussed above, the server computer 20 includes an HTML database 28a, a multimedia database 28b, a shockwave database 28c, an embedded HTML database 28d and an application server script database 28e. These database may store corresponding HTML files, multimedia files, shockwave files, embedded HTML files and application server script files in each of the respective databases 28. As is well known in the art, these files are either transferred to and accessed by the Web browser 38 or executed by the application server module 30. Application server script files are similar to HTML files in that they may contain HTML functions and are viewable by standard Web browsers, however, application server script files may also contain Cold Fusion functions which are only readable by the application server module 30 of the puzzle system 10.

Cold Fusion Software, by Allaire Corporation, is one of several software products developed for application servers which expand the functionality of the server computer 20. In the present invention, application server script functions are used to transfer game data 24 between the Web server module 40 and application server module 30 which includes an application server database 32 that may be comprised of user data, word dictionary data, puzzle data and other data. The application server module 30 works in tandem with the Web server module 40 and the other databases to provide extended functionality and database connectivity. For example, in addition to storing application server script files, the application server script database 28e may also execute functions such as logical operations or data manipulation which are beyond the scope of capabilities for the server computer 20 module by itself. Cold Fusion software is ODBC compliant, which allows the software to communicate with the databases. The aforementioned databases 28 and respective files are stored on the server computer 20 and accessible via the Internet 26.

The application server database 32 may also include a relational database that stores puzzle data and user data. Using standard data processing and storage techniques, the puzzle data and the user data may be linked together to enhance the ability to search for puzzle data that is associated with a specific user. The application server database 32 is accessed by the application server module 30 to perform a variety of the system's 10 functions, such as creating, editing, storing and accessing puzzles. The application server module 30 communicates with the application server database 32 to dynamically execute functions. The application server database 32 is also stored on the server computer 20 with the application server module 30. It should be understood by those with skill in the art, however, that the Web server module 40, the application server module 30 and the application server database 32 may also be housed within separate computers.

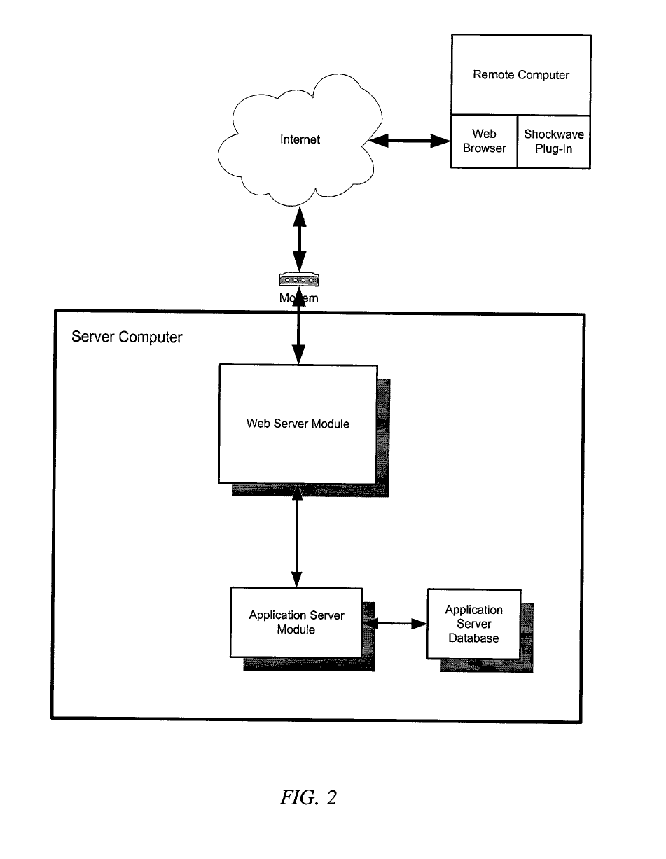

FIG. 2 shows a block diagram illustrating the Web browser 38 and its interaction with the server computer 20. As is known in the art, the puzzle system 10 employs a graphical user interface which is embodied within the Web browser 38 and which is accessible through standard Web browsing procedures. The Web browser 38 may interact with the server computer 20 in accordance with standard Internet protocols. A user may first connect to the system 10 by logging on to the Internet 26 with the remote computer 22 and by connecting to the Web site 36 for the system 10 located at the Uniform Resource Locator (“URL”) for the Web site 36, i.e., “http://www.apte.com/puzzles/”. After the user enters the URL for the Web site 36, the Web browser 38 may submit a request to the server computer 20 which resides at the URL entered by the user. Once located, the server computer 20 returns the Web site 36 content to the Web browser 38 of the remote computer 22. Upon receipt, the Web browser 38 may display the graphical and audio content for the Web site 36, which may contain hyperlinks to additional Web pages that collectively provide an interface for all of the functions for the system 10. Hyperlinks are Web addresses that are embedded in a word, phrase, icon or picture and that are activated when the user selects the highlighted hyperlink. When the user selects a hyperlink, the Web browser 38 retrieves the Web page associated with the selected hyperlink and the Web browser 38 displays the Web page. As shown in FIG. 2, the Web browser 38 allows the remote computer 22 to submit requests to the Web server module 40 and receive files or data from the server computer 20. The server computer 20 processes requests from the user by transferring files from its software modules or requesting files or data from the application server module 30. If the server computer 20 requests files or data from the application server module 30, the application server module 30 will process the request and provide the appropriate output to the server computer 20.

FIG. 1 shows the server computer 20 and its interaction with the various databases 28. In connection with the present invention, users may submit a variety of requests to the server computer 20. Some Web browser requests are hyperlinks to other Web pages of the system 10. These hyperlinks may also embody functions and allow the user to select particular functions by activating a correlating hyperlink. For example, assume hyperlink X accesses one of the functions for the system 10, which is displayed by a graphical user interface, i.e., Web page Z. By clicking hyperlink X from the home page, the user may trigger the Web browser 38 to submit a request to the server computer 20. This request may then be forwarded to the Web server module 40 which interprets the request and returns Web page Z to the Web browser 38. The Web pages for the puzzle system 10 are comprised of HTML commands, application server script commands or combinations thereof. The HTML commands may be processed by the server computer 20. The application server script commands may be passed to the application server module 30. After passing the application server script command to the application server module 30, the application server module 30 may process the specified application server script command. Then, the application server module 30 generates an output in a form that is readable by the server computer 20. The server computer 20 then receives and processes the output, resulting in the transfer of a correlating Web page to the Web browser 38. Embedded within the Web pages are a variety of elements such as images, audio clips and Shockwave files. The server computer 20 transfers these files to the Web browser 38 according to the instructions provided by the Web page. Selection of a Web page or function by the remote computer 22 allows the online puzzle system 10 users to create, edit, store and access puzzles electronically via the Internet 26.

The primary function of the server computer 20 is to process standard Web browsing requests. The primary function of the application server module 30 is to store and provide puzzle data and user data to the user and to process application service script commands. As previously mentioned, application server script commands extend the functionality of the puzzle system 10 by processing logical operations, such as IF/THEN/ELSE statements and by providing database connectivity. Standard Web server modules are not able to process logical operations or to dynamically process and store user provided information without utilizing application server script commands. Therefore, as is know in the art, the application server script database 28e may store application server script commands. User registration for the system 10 is a process that requires the advanced features provided by application server script commands. For example, when a user chooses to register for the system 10, the Web server returns the registration Web page to the Web browser 38. The registration Web page may be comprised of embedded HTML and CFML code. Upon receipt, the Web browser 38 processes the HTML commands and converts them into a graphical user interface format. When the user enters puzzle data or user data into the registration Web page, the Web browser 38 returns an application server script command along with the data back to the server computer 20. The server computer 20 may then pass the application server script command to the application server module 30 which will execute the request. After receiving the user registration data, the application server module 30 first checks the submitted data for any errors, using logical operations. If the data is valid, the application server module 30 may then open the database of the system 10 and create a new record. Upon completion, the application server module 30 generates an output in HTML format that confirms the new registration. This output is returned to the server computer 20 and then back to the user via the Web browser 38.

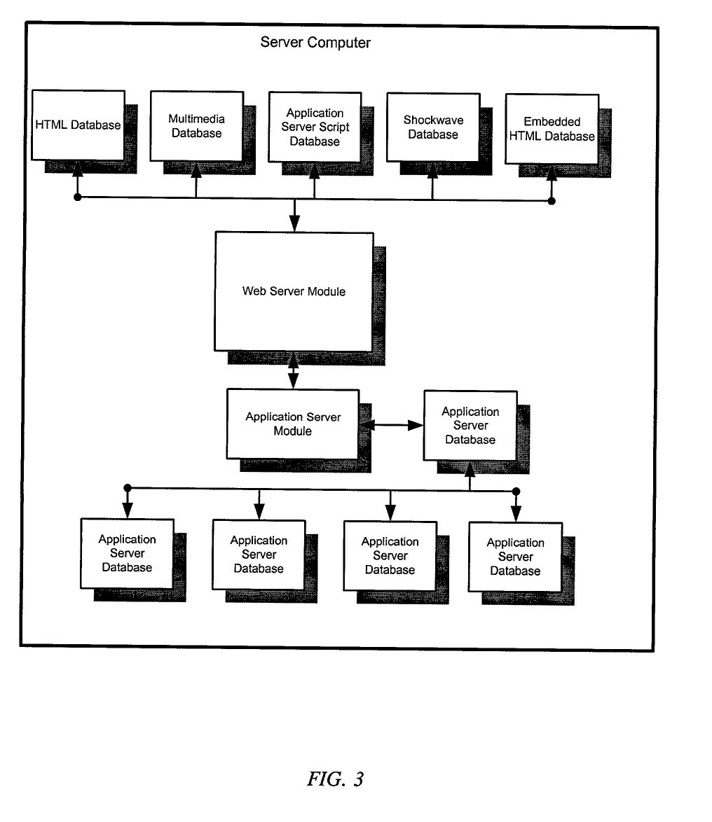

FIG. 3 shows a block diagram illustrating the application server module 30 and its interaction with the application server database 32. As discussed above, the application server module 30 adds database connectivity to the system 10. For example, in the preferred embodiment of the present invention, the database stores puzzle data and user data in tables along with word dictionary data and other data. Application server script commands provide for the dynamic allocation and manipulation of the data stored in the database. For example, the user may wish to edit a previously created puzzle or game. In this instance, after submitting login information, the application server module 30 will employ the user data provided during the login procedure to extract puzzle data from the database. The puzzle data is linked to the user's data. Once the user data is processed by the application server module 30, the application server module 30 generates a list of the user's previously created puzzles. The list of puzzles, which is in HTML-based Web page format, is passed to the Web server module 40 and then forwarded to the Web browser 38.

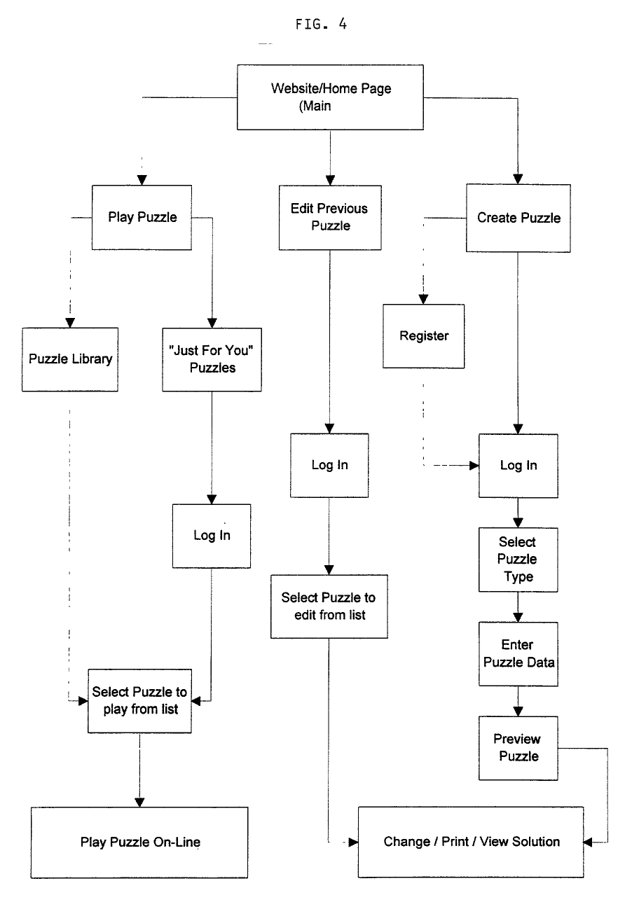

FIG. 4 shows a block diagram illustrating the relationship between the Web pages that make up the Web site 36 or graphical user interface of the puzzle system 10. The Web site 36 for the system 10 may be comprised of a collection of Web pages that perform a variety of functions described herein. Beneath the graphical user interface level lies the skeleton of the system 10, i.e., the interconnected software modules and databases 28 described above and shown in FIGS. 1 though 3. FIG. 4 also illustrate the organization and interrelationship between the Web site 36, the Web pages and the hyperlinks that connects each of these Web pages. Each block shown in FIG. 4 is a graphical representation of a Web page written in HTML and or CFML. Some components represent a Web page which includes numerous application server script commands that function together. For example, a user must first connect to the graphical user interface or Web site 36 of the puzzle system 10. Once the user accesses the Web site 36 of the puzzle system 10, the user can select a hyperlink to the Play Puzzle Web page, the Edit Puzzle Web page, or the Create Puzzle Web page. If the user chooses the Play Puzzle hyperlink, the system 10 returns a Web page that provides the user with a choice between the Puzzle Library Web page or the “Just For You” Puzzles Web page. Selecting the Puzzle Library hyperlink returns a list of generic puzzles that are available to any user. These puzzles are sorted by theme or by puzzle type. After the user selects a specific puzzle to play, the system 10 returns the puzzle to the user and allows the user to play the puzzle online. Selecting the “Just For You” hyperlink allows the user to play a puzzle created by another user. For example, if a student wanted to play a teacher's previously created puzzle, the student would select the “Just For You” link. The system 10 then requests the creator's/user's unique identifier variable designated during the registration process. The present embodiment of this invention uses the creator's e-mail address as the identifier variable. Hence, the student submits their teacher's email address and the system 10 returns a list of puzzles created by the teacher. The student then selects a puzzle from this list and plays the puzzle online. As shown in FIG. 4, the system 10 provides three major functions: Play Puzzle, Create Puzzle and Edit Puzzle.

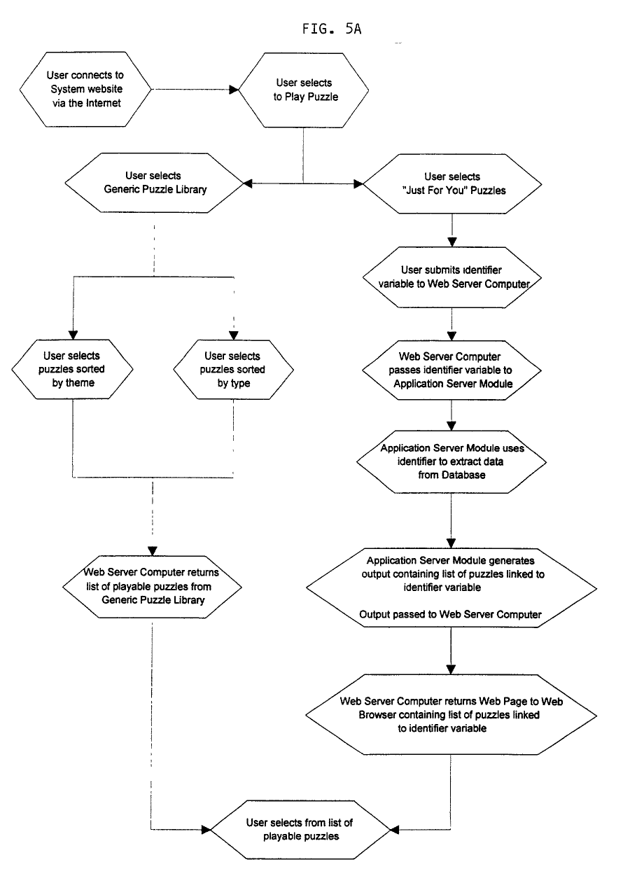

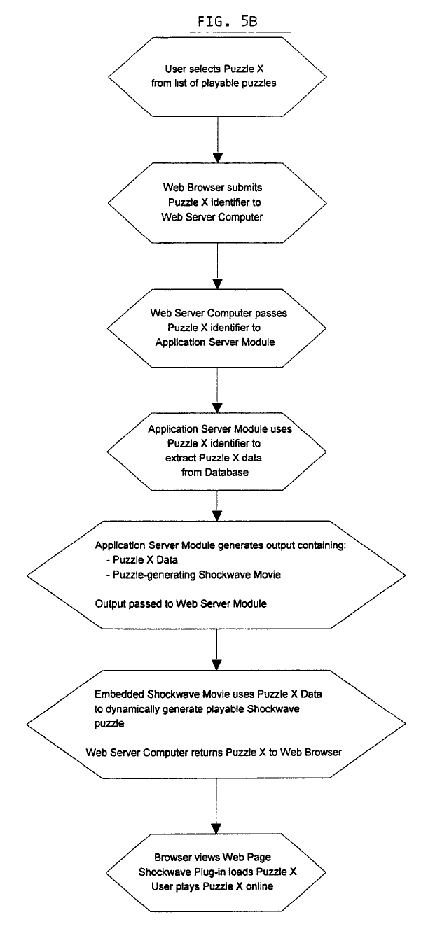

FIGS. 5A and 5B show the process steps for accessing the system 10 and playing a puzzle. The process begins with the user entering the HTTP address for the Web site 36 and thereby connecting to the Web server. This results in the Web server returning the Web site 36 for the puzzle system 10 to the Web browser 38. The Web browser 38 displays the Web site 36 which contains hyperlinks to other Web pages. One of the available hyperlinks is entitled Play Puzzle and as shown in FIGS. 5A and 5B, the user selects the Play Puzzle hyperlink. The Web server receives the request and returns the main Play Puzzle Web page. Once the user accesses the main Play Puzzle Web page, the user can choose to play a puzzle from the generic puzzle library or a puzzle created by another user, referred to as a “Just For You” puzzle.

Puzzles in the generic puzzle library are playable by any user and are provided by the puzzle system administrator. These puzzles can be sorted by subject, theme or puzzle type. If the user chooses to play a puzzle from the generic puzzle library, the server computer 20 returns a Web page that lists the sorted categories of available puzzles. Selecting a puzzle type, for example “crossword” returns a list of available puzzles of the specified type. Selecting a puzzle theme, for example “Presidents of the USA” returns a list of available puzzles involving the specified theme. This list of playable puzzles contains hyperlinks and application server script commands that are executed when the user selects a puzzle to play.

If a user selects a “Just For You” puzzle, the server computer 20 returns a Web page that asks the user for the creator's/user's identifier variable. As mentioned above, the present invention uses the creator's e-mail address as the identifier variable used to extract “Just For You” puzzle data from the database. Once the creator's e-mail address is submitted through the Web page, embedded application server script commands return the data to the application server module 30. Then, the application server module 30 opens the application server database 32and extracts the necessary puzzle data which is linked to the creator's e-mail address. Using this data, the application server module 30 generates a Web page listing the names of puzzles created by the user whose e-mail address was submitted. This Web page is returned to the server computer module and then back to the Web browser 38. This list of playable puzzles contains hyperlinks and application server script commands that are executed when the user selects a puzzle to play.

FIG. 5B shows additional steps for selecting and playing a puzzle. In the present example, the user chooses Puzzle X from the list of playable puzzles. Clicking the Puzzle X hyperlink causes application server script commands to be sent back to the server computer 20. The application server module 30 uses the Puzzle X identifier to extract all data linked to Puzzle X from the database. The application server module 30 generates an output containing Puzzle X data and an embedded Shockwave movie that is capable of generating a playable version of Puzzle X. The Shockwave movie uses the data to generate Puzzle X dynamically. The output is then returned to the server computer 20 and Web browser 38 as a Web page and displayed to the user by the Web browser 38. Upon receipt, the Web browser 38 identifies Shockwave content contained within the Web page. The Shockwave plug-in loads the playable puzzle onto the Web browser 38 and then displays the playable puzzle.

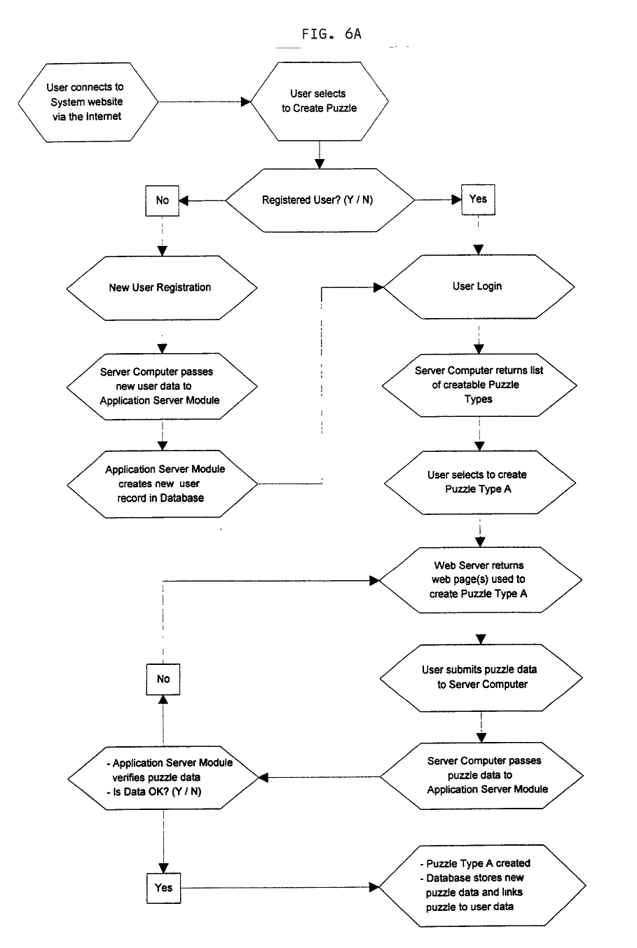

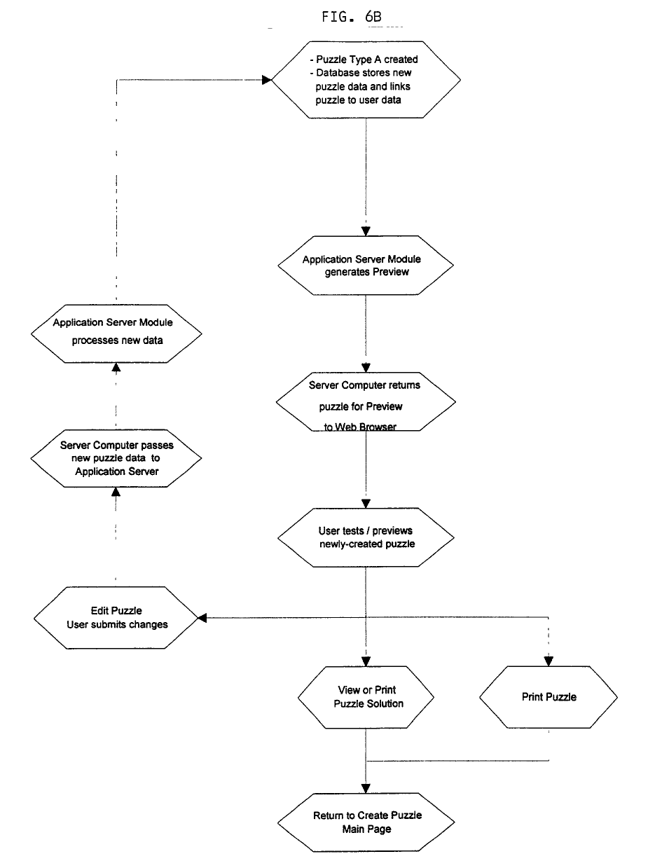

FIGS. 6A and 6B show the process steps for accessing the system 10 and creating a puzzle. The process begins with the user entering the HTTP address for the system 10 and connecting to the server computer 20. Then, the server computer 20 returns the Web site 36 to the Web browser 38. The Web browser 38 displays the Web site 36 to the user which contains hyperlinks, including a hyperlink entitled Create Puzzle and as shown in FIGS. 8A and 8B, the user selects the Create Puzzle hyperlink. The Web server receives the request and returns the main Create Puzzle Web page. Next, the system 10 requires the user to register by entering a user name and password before allowing the user to access the Create Puzzle function. If the user is not registered with the system 10, the main Create Puzzle page offers a hyperlink to the registration Web page(s). When selected, the Web server returns a sequence of Web pages that collect user data from the user via the Web browser 38. Application server script commands that are embedded within these registration Web page(s) return the submitted user data to the application server. The application server module 30 then processes the application server script commands and opens the application server database 32. Once the application server database 32 is opened, the application server module 30 creates a new user record.

After the registration process, the user can proceed with the Create Puzzle function by logging-in to the system 10. At the Create Puzzle login page, the user submits their previously established username and password. The application server module 30 receives the username and password and verifies the validity of the username and password. Once verified, the system 10 returns the main Create Puzzle Web page. The main Create Puzzle Web page lists a variety of available puzzle types that the user can select and create. If the user selects Puzzle Type A, the server computer 20 returns the Web page(s) that provide a template for creating the specified puzzle type, i.e., Puzzle Type A. The user then enters the appropriate parameters for Puzzle Type A into the template. Once the user has entered the required parameters, the puzzle data is transferred to the server computer 20 and the application server module 30. Application server script commands are used to transfer the puzzle data to the application server module 30 and the validity of the puzzle data is verified by the application server module 30. The puzzle data is verified by checking the data for errors and for consistency with the specifications for the system 10. If the data does not satisfy the requirements, the system 10 returns an error Web page followed by a hyperlink to the Start Over Web page. If the application server module 30 determines that the submitted puzzle data satisfies the parameters required for Puzzle Type A, the application server module 30 opens the database and stores the puzzle data in the database. This data is also linked to the puzzle creator's user data.

FIG. 6B shows additional steps in the Create Puzzle process. After storing the newly created puzzle data, the application server module 30 generates a Puzzle Preview 42a Web page that contains a previewable version of the new puzzle. This Web page is returned to the Web browser 38 and allows the user to test the new puzzle. The Puzzle Preview Web page 42a functions similarly to the Play Puzzle Web page 42b and uses the Shockwave browser plug-in module to play the puzzle. If the user is not satisfied with the new puzzle, the user can change and resubmit the puzzle's data to the server computer 20. Otherwise, the user can view or print the new puzzle's solution. The puzzle solution is dynamically generated by the application server module 30 and returns the solution in Web page format to the Web browser 38. The user can also select the Print Puzzle hyperlink 44a to generate a printable version of the new puzzle. This version is also dynamically generated in Web page form by the application server module 30, however, the printable version of the new puzzle is not playable online. At this point, the user has the option of returning to the main Create Puzzle Web page 42c to create another puzzle.

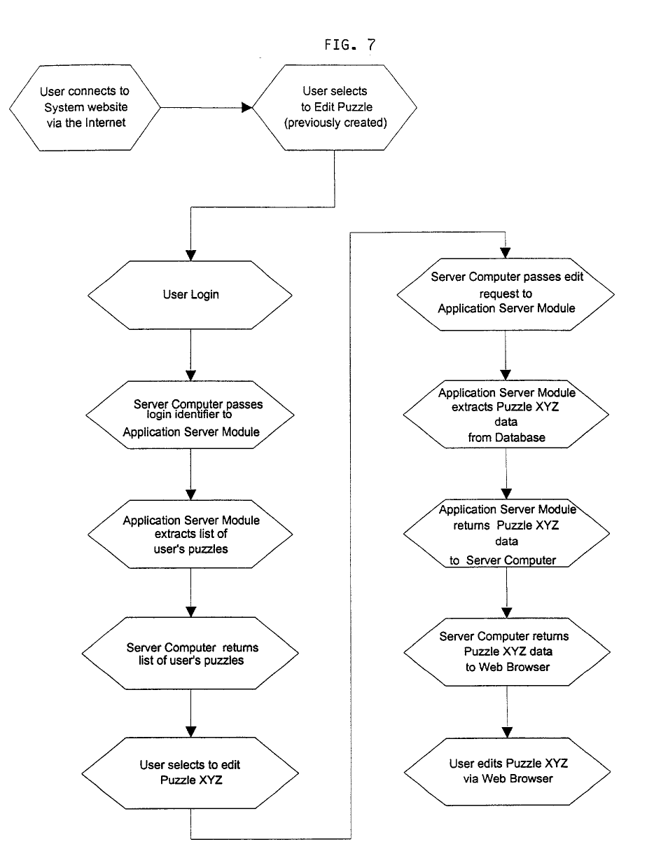

FIG. 7 shows the process steps for accessing the system 10 and editing a puzzle. The process begins with the user entering the HTTP address for the system 10 and connecting to the puzzle server computer 20. Then, the server computer 20 returns the Web site 36 to the Web browser 38. As shown in FIG. 7, the Web browser 38 displays the Web site 36 which contains hyperlinks 44 such as the Edit Puzzle hyperlink 44b and as further shown in FIG. 7, the user selects the Edit Puzzle hyperlink 44b. The Edit Puzzle Web page 42d is only accessible by users that have completed the registration process. Therefore, the system 10 may begin by returning the login Web page 42e, where the user submits their username and password. Once the user has logged in to the puzzle system 10, the puzzle system 10 may return a Web page 42 containing a list of puzzles that are linked to the user data specified during the login procedure. However, instead of selecting a puzzle to play, the user selects a puzzle to edit from this list. For example, if the user chooses to edit Puzzle XYZ, created during a previous Web browsing session, the application server module 30 may open the database and extract all of Puzzle XYZ's data. The application server module 30 may then generates a Web page 42 similar to the Preview Page Web page 42a used in the Create Puzzle function. This Web page is returned to the Web browser 38, where the user can change the data used for Puzzle XYZ. When finished, the user can return to the main Edit Puzzle Web page 42d to revise other previously created puzzles. The main Edit Puzzle Web page 42d also provides puzzle creators with the option of deleting any previously created puzzle. When deleting a puzzle, the application server module 30 opens the database and erases all the data linked to the puzzle marked for deletion.

In addition to the preferred embodiment described above, the following descriptions specify other possible embodiments or adaptations of the present invention.

The system 10, as described above, specifies different modules that comprise the invention. These modules describe software applications and files that can be stored on any number of physical machines and in a variety of configurations. Thus, the system 10 can be represented in various methods as long as the modules and their relationships are consistent with the preferred embodiment.

The Web server module 40 and Application server module 30 described in the present invention refer to industry standard, commercially available software products. The invention can be implemented with any Web Server Module products and any Application server module 30 products as long as they are consistent with the functionalities that are required by the system 10. This also applies to the Web browser 38.

The preferred embodiment of the graphical user interface for the system 10 and process flow for utilizing the system 10 is illustrated in FIGS. 4-7. The invention can also be recreated using variations on this basic interface design by restructuring, adding or deleting elements described in the invention. Any changes in the main user interface would subsequently affect the process flow and any diagrams that describe them.

One of the components in the preferred embodiment is a database comprised of multiple data tables and data types. This database can be constructed and organized using different variations to suit the needs of the current or alternative embodiments of the system 10. This also pertains to the inclusion of different data types that satisfy the functions of the system 10.

The preferred embodiment of the system 10 provides puzzles in the English Language. Because of the flexibility of the system's design, however, a French Language version of the invention currently exists, and a Spanish Language version is currently in development. This mainly involves the representation of the user interface, and not the underlying design. Therefore, the system 10 could be modified to support any foreign language.

In addition, currently an alternative embodiment to this system 10 exists that allows users to send puzzles to other users as attachments to animated greeting cards. The user creates a puzzle as described above, then chooses from a selection of animated themes made available by the system 10. The user specifies the recipient and message contents before sending the puzzle greeting electronically. Once notified, the recipient can connect to the system 10 to dynamically retrieve their greeting and play the specified puzzle online. The sender can also select from a list of previously created puzzles to send with a greeting.

The order of all steps disclosed in the figures and discussed above has been provided for exemplary purposes only. Therefore, it should be understood by those skilled in the art that these steps may be rearranged and altered without departing from the spirit of the present invention.

While the invention has been particularly shown and described with reference to a particular embodiment thereof, it will be understood by those skilled in the art that various changes in form and detail may be made therein without departing from the spirit and scope of the invention. For example, the process described with respect to computer executable instructions can be performed in hardware or software without departing from the spirit of the invention. The present embodiment, therefore, is to be considered in all respect as illustrative and not restrictive, and the invention should be given the full breadth of the appended claims and any equivalents thereof.

What is claimed is:

1. A method for allowing a remote computer to create, edit, store and access a computer game stored on an online puzzle system via the Internet, comprising:
accessing the system with the remote computer which includes a Web browser;
presenting a plurality of commands to the remote computer for selection by a user operating the remote computer via the Web browser, the commands corresponding to the functions available on the online puzzle system;
receiving a selected command from the remote computer, the command causing the system to access a correlating Web page and the Web page requesting game data for executing a selected command;
receiving game data for executing the selected command and the function associated with the selected command; and
applying design rules to the game data to dynamically generate at least one computer game capable of being played by the user via the Web browser in conjunction with the remote computer.

2. The method for allowing a remote computer to edit, store and access a computer game stored on an online puzzle system as defined in claim 1, further including sending the generated computer game to a remote computer.

3. The method for allowing a remote computer to create, edit, store and access a computer game stored on an online puzzle system as defined in claim 1, further including:
storing the generated computer game on the server computer; and
linking the generated computer game to a user identifier for allowing an entire group of generated computer games for a specified user to be provided to a remote computer.

4. The method for allowing a remote computer to create, edit, store and access a computer game stored on an online puzzle system as defined in claim 1, further including providing a Web server and an application server module for allowing data to be passed between the remote computer to the system.

5. The method for allowing a remote computer to edit, store and access a computer game stored on an online puzzle system as defined in claim 4, further including providing an application server script module, the application server script module being capable of allowing the system to process application server script functions in conjunction with the Web server module.

6. The method for allowing a remote computer to edit, store and access a computer game stored on an online puzzle system as defined in claim 1, further including providing the online puzzle system with a movie module, the movie module allowing the system to generate interactive puzzles that are viewable by the Web browser of the remote computer.

7. The method for allowing a remote computer to edit, store and access a computer game stored on an online puzzle system as defined in claim 1, further including providing a system with an embedded HTML module, the embedded HTML module allows the system to dynamically generate and display interactive content using data extracted from the system.

8. An online puzzle system that enables a remote computer to create, edit, store and access a computer game via the Internet, comprising:
a server computer that is connected to the Internet and that includes an application server module;
the application server module including a database comprised of user data and puzzle data; and
a Web site produced by the Web server computer and accessible by the remote computer via the Internet, whereby the Web site is capable of displaying information to a user via the remote computer in conjunction with a Web browser, exchanging information with the user and accessing the database stored in the application server module and whereby the user is able to create, edit, store and access puzzles on said Web site.

9. The system according to claim 8, wherein the system further includes an HTML module, the HTML module allowing the system to process standard hypertext protocol functions.

10. The system according to claim 8, wherein the system further includes a multimedia module, the multimedia module allowing the system to send the remote computer animation and sound content and the remote computer being capable of receiving and displaying the content via the Web browser.

11. The system according to claim 8, wherein the system further includes an application server script module, the application server script module allowing the system to process application server script functions in conjunction with the Web server module.

12. The system according to claim 8, wherein the system further includes a movie module, the movie module allowing the system to generate interactive puzzles that are viewable by the remote computer in conjunction with the Web browser.

13. The system according to claim 8, wherein the system further includes an embedded HTML module, the embedded HTML module allowing the system to dynamically display interactive content generated from data extracted from the system to the remote computer via the Web browser.
